(19) United States
(12) Patent Application Publication
(10) Pub. No.: US 2012/0214109 A1
(43) Pub. Date: Aug. 23, 2012

(54) FLUIDIZING NOZZLE WELD COLLAR

(75) Inventors: Thomas F. Begina, Windsor, CT (US); Thomas R. Bober, Amston, CT (US); Jeremy A. Ryser, Simsbury, CT (US); Michael C. Tanca, Tariffville, CT (US)

(73) Assignee: ALSTOM Technology Ltd, Baden (CH)

(21) Appl. No.: 13/031,831

(22) Filed: Feb. 22, 2011

(51) Int. Cl. F27B 15/10; B23P 6/00; F23D 14/26

(52) U.S. Cl. 431/170; 432/58; 29/402.08

(57) ABSTRACT

A unique nozzle [20] for a fluidized bed reactor is described that may be replaced efficiently. This employs a collar [30, 130, 230] attached to a vertical section [15] of a feed pipe [11] that provides fluidizing gases. The vertical section [15] has a plurality of nozzle openings [17] at its upper end. A nozzle cap [19] fits over the upper end of the vertical section [15] and the nozzle openings [17]. The collar [30, 130, 230] extends radially outward from the vertical section [15] at a location just below the nozzle cap [19] supporting it in its operational position. During replacement of the vertical section [15] and the nozzle cap [19], the collar acts as a guide to direct cutting equipment to the proper location and facilitate proper cuts. The collar [30, 130, 230] also acts as a support to hold the vertical section [15] and the nozzle cap [19] in proper position to facilitate welding.

### TECHNICAL FIELD

The devices described herein relates to fluidizing nozzles and more specifically to fluidizing nozzles designed for easy replacement.

### BACKGROUND

Fluidizing nozzles are used to direct fluids upward through a bed of particles causing at least some of the particles to become suspended within the fluid. This causes interaction between the particles and/or the fluids causing increased chemical reactions.

Many times these reactions are exothermic, creating heat. The fluidizing nozzle tends to corrode, become plugged and deteriorate after significant usage. The fluidizing nozzles must then be serviced or replaced after a finite period of operation.

FIG. 1 shows prior art fluidizing nozzles 10 within a fluidizing bed 23 of reactive particles. Fluid, such as air or combustion gasses are provided through at least one plenum or feed pipe 11 having a horizontal section 13 below the bed floor 27. The feed pipe 11 turns upward and have a vertical section 15 that passes through floor openings 29 in bed floor 27.

The vertical section has nozzle openings 17 which are proximate to the top end of the vertical section 15. The nozzle openings 17 may be on the sides and/or top of the feed pipe 11. Typically, the top of each vertical section 15 has a nozzle cap 19. The nozzle cap 19 also has cap holes 21 for allowing the fluid to exit the nozzles 10.

The nozzle cap 19, the nozzle openings 17 and the cap holes 21 holes need to be reworked periodically in order to keep them open and at an optimal hole diameter to achieve proper performance. If they are too corroded or blocked, they must be removed and replaced.

The most common current replacement means is to cut off the nozzle cap 19 and vertical section 15 at a point on the feed pipe below the nozzle cap 17, as indicated by arrow “A”. A new nozzle cap 17 and vertical section 15 must be welded onto the remaining vertical section 15 of the old feed pipe 11. This involves welding the new vertical section 15 of feed pipe 11 to the old remaining vertical section 15 end-to-end, longitudinally. It is generally difficult to line up the pipes and hold them in place while welding them around their perimeters in a confined welding area. Also, since that may be hundreds of nozzles 10, this can become very time-consuming.

Since the feed pipes and other structures are under the bed floor 27, the replacement is performed from the side above the bed floor 27.

Arrow “A” in FIG. 1 points to the location where the vertical section 15 should be cut. Due to the curvature of nozzle cap 19, and the tight spacing of the nozzles 10, it is difficult to access the location with the proper instruments and equipment. Since access is difficult, it is even more difficult to hold the replacement feed pipe in place and weld the pipe at the same time, making sure that there is a continuous bead all around the pipes, preventing leakage of the fluid. Due to these problems, the welds are not always optimal leading to leakage and decreased efficiency, and the time it takes for replacement is excessive. This leads to expensive, prolonging outages.

The nozzle cap 17 must be welded to the end of the fluidizing pipe. Insufficient access to properly weld on a new cap can result in a poor weld and causing the cap to fall off.

Currently, there is a need for a fluidizing nozzle that is easier to replace.

### SUMMARY OF THE INVENTION

The present invention is described as a fluidized bed nozzle [20] capable of being replaced in an efficient manner having a plenum or feed pipe [11] having a vertical section [15] positioned substantially vertically capable of receiving and directing fluids out through nozzle openings [17] at a top end of the vertical section [15], a nozzle cap [19] shaped to fit over the top end of vertical section [15] of the feed pipe [11], and a collar [30, 130, 230] having an inner opening [31] for receiving the vertical section 15 of the feed pipe [11] being attached at a location and extending horizontally outward from the vertical section [15] to support the nozzle cap [19] at a proper operation position.

The present invention may also be embodied as a method of creating a quick replacement fluidized bed nozzle [20] by providing a collar [30, 130, 230] having an inner opening [31,131,231] sized to receive at least one vertical section [15] of feed pipes [11] for the fluidized bed, determining a vertical location on the vertical section [15] that coincides with the bottom of a nozzle cap [19] of a fluidized nozzle when it is properly installed on the vertical section [15], fitting the collar [30, 130, 230] onto at least one vertical section [15], securing the collar [30, 130, 230] to the vertical section [15] at the determined vertical location, installing the nozzle cap [19] such that it rests upon the collar [30, 130, 230], and securing the nozzle cap [19] to the collar [30, 130, 230].

The present invention may also be embodied as a method of quickly replacing a fluidizing nozzles [20] having a nozzle cap [19] attached a collar [30, 130, 230] fitting over and extending radially away from a vertical section [15] of a feed pipe [11], by sliding an instrument along the collar [30, 130, 230] so as to direct the instrument to an attachment point between the nozzle cap [19] and the collar [30, 130, 230], using the instrument at the attachment point to free the nozzle cap [19], removing the nozzle cap [19], cutting off a top portion of the vertical section [15], providing a replacement vertical section [15], supporting the replacement vertical section [15] in the proper position, orientation for welding, welding the replacement vertical section [15] to what is remaining of the vertical section [15], positioning a replacement nozzle cap [19] over the replacement vertical section such that it rests upon and is held by the collar [30, 130, 230], and securing the replacement nozzle cap [19] to the collar [30, 130, 230].

### BRIEF DESCRIPTION OF THE DRAWINGS

The subject matter described in the description of the preferred embodiments is particularly pointed out and distinctly claimed in the claims at the conclusion of the specification. The foregoing and other features and advantages are apparent from the following detailed description taken in conjunction with the accompanying drawings in which:

FIG. 1 is a sectional side elevational view of a prior art fluidizing bed with fluidizing nozzles.

FIG. 2 is a side elevational view of one embodiment of a fluidizing nozzle 20 according to the present invention.

FIG. 3 is sectional view of the fluidizing nozzle 20 as viewed from line “III”-“III” of FIG. 2.

FIG. 4 is a perspective view of the fluidizing nozzle 20 according to the present invention as viewed from above.

FIG. 5 is a perspective view of the fluidizing nozzle 20 according to the present invention as viewed from below.

FIG. 6 is a side elevational view of one embodiment of the fluidizing nozzle 20 according to the present invention with its nozzle cap 19 removed.

FIG. 7 is sectional view of the fluidizing nozzle 20 as viewed from line “VII”-“VII” of FIG. 6.

FIG. 8 is a plan view of another embodiment of a collar according to the present invention.

FIG. 9 is a plan view of another embodiment of a collar according to the present invention.

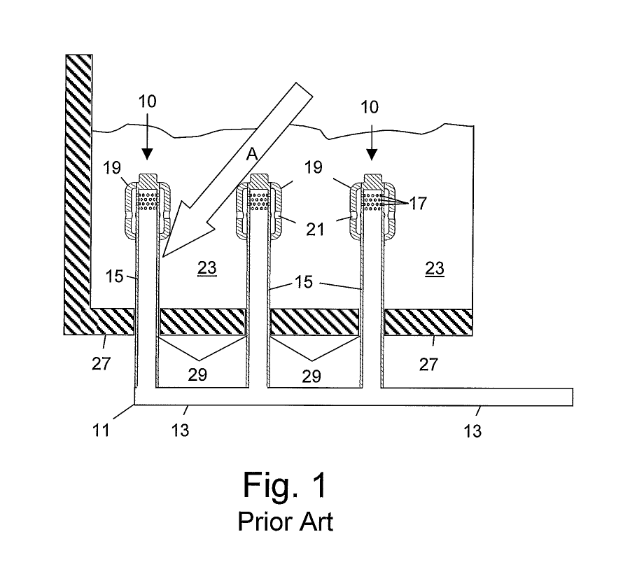

### DESCRIPTION OF THE PREFERRED EMBODIMENTS

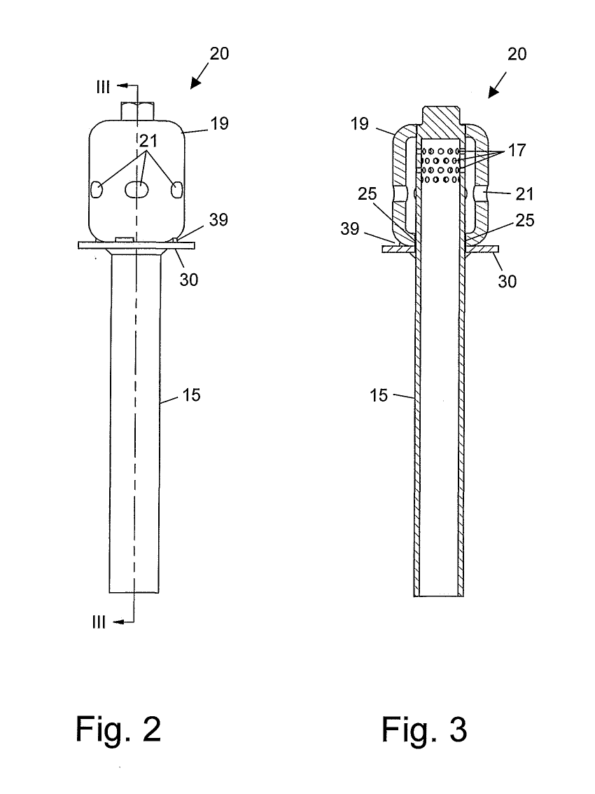

Since there are numerous nozzles to replace in a fluidizing bed, saving even a small amount of time/effort replacing each nozzle equates to significantly reduced outage time and large cost savings. It was determined that if there was a means of holding the replacement nozzle cap and or the replacement vertical section in place, welding would become much more efficient. FIGS. 2 show the present invention incorporating a nozzle collar 30 fitting around, and welded to the vertical section 15 of the feed pipes 11. Collar 30 is welded at a location corresponding to the bottom of the nozzle cap 19.

Now when replacing the nozzle cap 19 and the internal vertical section 15, both may be cut at the point where the nozzle cap 19 meets the collar 30. The replacement vertical section 15 may rest upon the collar 30 and can be welded easily from the side or at an angle form above.

Also, the cap may be placed over the new vertical section 15 and rest upon the collar 30. It is now held in the proper position for welding. It may be fully welded, or only tack welded at a few locations around the bottom of the nozzle cap 19 where it meets the collar 30. This will allow the nozzle cap 19 to be easily removed during the next replacement by simply cutting the tack welds.

The weld ring 30 allows for easier installation and removal of the nozzle cap 19. This allows a simple welding procedure for welding new fluidizing nozzle heads to be performed from above the nozzles to facilitate the fluidizing nozzle replacement procedure.

The collar 30 also prevent the nozzle cap 19 from falling off and into the fluidizing bed if the welds break due to vibration, thermal shock and other phenomena.

FIG. 2 is a side elevational view of one embodiment of the vertical section 15 of the feed pipe 11 and weld collar 30 of the fluidizing nozzle 20 according to the present invention. The vertical section 15 of feed pipe 11 is shown. Collar 30 is welded to the vertical section 15 at the bottom of nozzle cap 19 at a location such that when nozzle cap 19 rests on collar 30, it is in its proper operational position relative to vertical section 15. Nozzle cap 19 is attached to collar 30, preferably with the use of small welds at several locations called “tack welds” 39. These are easy to apply and easy to remove.

Cap holes 21 surround nozzle cap 19 allowing fluids provided to the nozzle cap 19 to exit into the fluidizing bed.

FIG. 3 is sectional view of the feed pipe and weld collar as viewed from line “III”-“III” of FIG. 2. Here the relationship of the nozzle cap 19, collar 30 and vertical section 15 can be more clearly seen. If just the nozzle cap 19 is to be replaced, then the tack welds holding nozzle cap 19 on can be cut. Nozzle cap 19 fits over vertical section 15 and rests upon collar 30, securing it prior to welding.

If both the nozzle cap 19 and the top of vertical section 15 are to be replaced, then the nozzle cap 19 would be removed and the top of the vertical section 15 would be cut at the collar 30. Equipment such as a saw blade can be placed upon the top surface of collar 30. During cutting, the blade or grinding wheel is allowed to slide along the top surface of collar 30 inwardly creating a clean, cut parallel to the collar surface. This provides a flat base on which to put the replacement vertical section 15 also having a matching flat end. A replacement vertical section 15 is placed upon the collar surface allowing it to be in proper position for welding. The flat cut allows for a clean and accurate weld of matching vertical section 15.

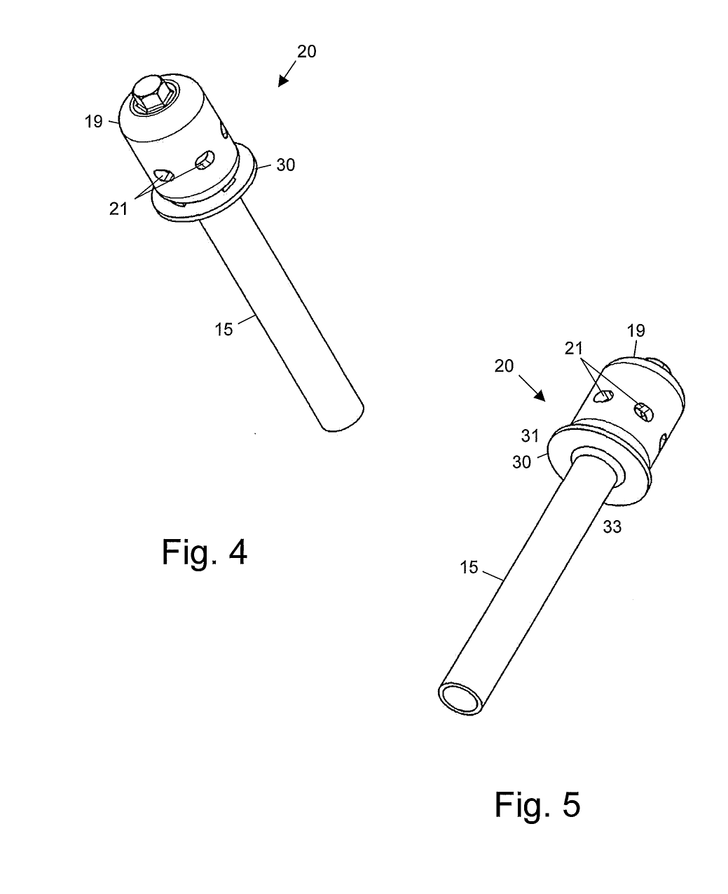

FIG. 4 is a perspective view of the fluidizing nozzle 20 according to the present invention as viewed from above. The nozzle cap 19 with cap holes 21, collar 30 and vertical section 15 are shown.

FIG. 5 is a perspective view of the fluidizing nozzle 20 according to the present invention as viewed from below. This shows a better view of the collar 30 that is disc-shaped in this embodiment. However, there are other embodiments which also fall under the scope of the present invention that are described in greater detail later.

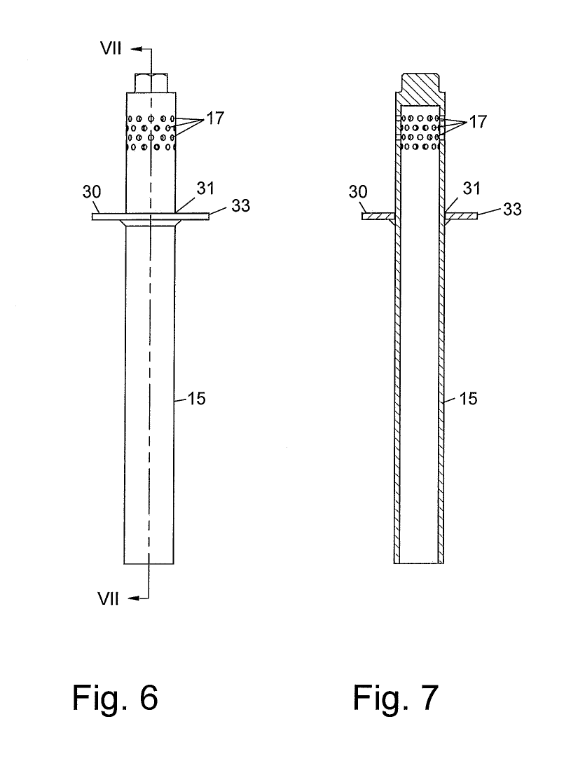

FIG. 6 is a side elevational view of one embodiment of the fluidizing nozzle 20 according to the present invention with its nozzle cap 19 removed. When the nozzle cap 19 is being replaced, this view shows how the cap is easily positioned over the top of the vertical section 15 without error and held in the proper position for welding by collar 30.

FIG. 7 is sectional view of the fluidizing nozzle 20 as viewed from line “VII”-“VII” of FIG. 6. The diameter of the vertical section 15 of this embodiment is constant and therefore does not have any outward extensions other than the collar 30 that could be used to hold the nozzle cap at its proper location along vertical section 15 for welding. Without collar 30, the proper location along vertical section 15 would have to be measured and the nozzle cap 19 would have to be secured at the measured location by additional equipment for welding. Since it is very cramped between the nozzles, this would be very difficult and time consuming. Incorrect measurements and movement prior to welding would require re-work that significantly increases the time required.

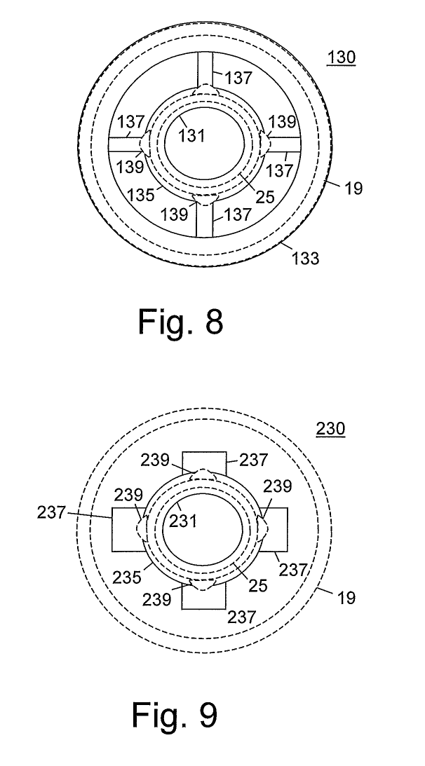

FIG. 8 is a plan view of another embodiment of a collar 130 according to the present invention. In this embodiment approximates the collar 30 but includes open areas. There is an outer ring 133 connected to a hub 135 by supports 137. The hub 135 has a central opening 131 sized to receive the vertical section 15. Hub 135 is attached to vertical section 15. The dashed lines closest to the center indicate cap opening 25 and the outer two lines indicate the inner and outer walls of the widest portion of nozzle cap 19. The nozzle cap 19 is tack welded to the hub 135 and supports 137, holding the nozzle cap 19 in place.

Upon replacement of the nozzle cap 19, outer ring 133 and supports 137 act as a guide for a saw to cut the tack welds. They also act as a support for the replacement vertical section 15 and replacement cap 19 during welding.

FIG. 9 is a plan view of another embodiment of a collar 230 according to the present invention.

In this embodiment, collar 230 does not have to be disc-shaped but extend outwardly enough to hold cap 19 in a position so that it may be welded upon installation. Collar 230 has a hub 235 having supports 237 outwardly from the hub 235. Cap opening 25 is sized to be supported by hub 235 and/or supports 237. Tack welds 239 secure the nozzle cap 19 to the hub 235 and supports 237.

Therefore, there are several advantages to using a collar 30 as defined by the present invention.

This design allows for cap removal and air nozzle cleaning and subsequent reinstallation without removal of the feed pipe from the floor.

This design allows for easy removal of the cap from the pipe by cutting the weld at the cap/collar interface from above, The design also allows for reinstallation of the cap onto the collar from above with a weld.

The speed of fluidized nozzle maintenance will be greatly increased, resulting in shorter customer outage times.

The cap will be less susceptible to falling off the nozzle pipe due to better access for welding.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A fluidized bed nozzle capable of being replaced in an efficient manner comprising:
a feed pipe having a vertical section positioned substantially vertically capable of receiving and directing fluids out through nozzle openings at a top end of the vertical section;
a nozzle cap shaped to fit over the top end of vertical section of feed pipe; and
a collar having an inner opening for receiving the vertical section of the feed pipe being attached at a location and extending horizontally outward from the vertical section to support the nozzle cap at a proper operation position.

2. The fluidized bed nozzle of claim 1, wherein the collar has a disk shape with a central orifice 31 is sized to fit over the vertical section of feed pipe.

3. The fluidized bed nozzle of claim 1, wherein the nozzle cap is attached to the collar with at least one tack weld.

4. The fluidized bed nozzle of claim 1, wherein the collar has at least one substantially horizontal support adapted to guide toward the at least one tack weld.

5. The fluidized bed nozzle of claim 1, wherein the collar is comprised of:
a hub having the inner opening; and
at least one substantially support extending horizontally adapted to guide toward the at least one tack weld.

6. The fluidized bed nozzle of claim 5, wherein the collar further comprises:
an outer ring connected to the supports extending substantially horizontally adapted to facilitate support of the nozzle cap and vertical section upon replacement.

7. A method of creating a quick replacement fluidized bed nozzle comprising the steps of:
providing a collar having an inner opening sized to receive at least one vertical section of feed pipes for the fluidized bed;
determining a vertical location on the vertical section that coincides with the bottom of a nozzle cap of a fluidized nozzle when it is properly installed on the vertical section;
fitting the collar onto at least one vertical section;
securing the collar to the vertical section at the determined vertical location;
installing the nozzle cap such that it rests upon the collar; and
securing the nozzle cap to the collar.

8. The method of claim 7, wherein the nozzle cap is secured to the collar with at least one tack weld.

9. The method of claim 7, wherein the collar has a disk shape with a central orifice sized to fit over the vertical section of the feed pipe.

10. The method of claim 7, wherein the step of providing a collar comprises the step of:
providing a collar with a hub having the inner opening; and at least one support extending substantially horizontally.

11. The method of claim 7, wherein the step of providing a collar comprises the step of:
providing a collar with a hub 135 having the inner opening; and at least one support extending substantially horizontally connected to an outer ring to facilitate support of the nozzle cap and vertical section upon replacement.

12. A method of quickly replacing fluidizing nozzles having a nozzle cap attached a collar fitting over and extending radially away from a vertical section of a feed pipe, comprising the steps of:
sliding an instrument along the collar so as to direct the instrument to an attachment point between the nozzle cap and the collar;
using the instrument at the attachment point to free the nozzle cap;
removing the nozzle cap;
cutting off a top portion of the vertical section;
providing a replacement vertical section;
supporting the replacement vertical section in the proper position, orientation for welding;
welding the replacement vertical section to what is remaining of the vertical section;
positioning a replacement nozzle cap over the replacement vertical section such that it rests upon and is held by the collar; and
securing the replacement nozzle cap to the collar.

13. The method of claim 12 wherein the step of securing the replacement nozzle cap, comprises the step of:
securing the replacement nozzle cap with at least one tack weld.
